(19) United States
(12) Patent Application Publication
(10) Pub. No.: US 2006/0242457 A1
(43) Pub. Date: Oct. 26, 2006

(54) Method and apparatus for coordinating seamless channel switching in a mesh network

(75) Inventors: Vincent Roy, Montreal (CA); Marian Rudolf, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/398,143

(22) Filed: Apr. 4, 2006

Related U.S. Application Data
(60) Provisional application No. 60/669,550, filed on Apr. 8, 2005.

(51) Int. Cl. G06F 11/00

(52) U.S. Cl. 714/12

(57) ABSTRACT

A mesh network including at least one channel master (CM) and a plurality of mesh points (MPs). The CM sends a channel change intention message to at least one of the MPs indicating the CM's intention to change from a first channel to a second channel. Upon reception of the channel change intention message, the at least one MP determines whether to switch from the first channel to the second channel. The at least one MP sends a channel change response message to the CM. The CM then determines whether to change from the first channel to the second channel based on the channel change response message. The channel change intention message may indicate a change of mode, a change of bandwidth or a change of a number of channels. The channel change intention message may indicate the timing of the channel change.

### CROSS REFERENCE TO RELATED APPLICATION

This application claims the benefit of U.S. provisional application No. 60/669,550 filed Apr. 8, 2005, which is incorporated by reference as if fully set forth.

### FIELD OF INVENTION

The present invention is related to wireless mesh networks. More particularly, the present invention is related to seamlessly coordinating channel changes to improve the radio efficiency of mesh networks.

### BACKGROUND

Typical wireless system infrastructures include a set of access points (APs), also referred to as base stations (BSs), each connected to a wired network through what is referred to as a backhaul link. In some scenarios, the high cost of connecting a given AP directly to the wired network makes it more attractive instead to connect the AP indirectly to the wired network through via its neighboring APs. This is referred to as a mesh architecture. The advantages of using a mesh infrastructure are ease-of-use and speed of deployment, since a radio network can be deployed without having to provision backhaul links and interconnection modules for each AP.

In a mesh network, two adjacent mesh points (MPs) have to use a common channel to be able to forward packets one to another. The level of interference perceived by the different MPs may vary widely both geographically and in time. This implies that a channel might be perceived to have little interference by one MP while another MP suffers from high levels of interference on the same channel. Similarly, an MP may suffer from very little interference on a given channel at one point in time, while the same MP on the same channel may suffer from high levels of interference at another point later in time. This implies that MPs face conflicting needs and preferences in terms of which channels to use. This can be summarized by the following:

1) MPs have strong incentives to use the same channel as other MPs in order to enhance their connectivity to the mesh network. Moreover, the mesh network has strong incentives for the MPs to be able to communicate with each other.

2) At any given moment, different MPs in a mesh network see different levels of interference of each channel, and thus have different individual preferences as to which channel to use.

3) The interference perceived by each MP changes in time, which means that a channel that was found to be optimal for the mesh network at one instant might not be adequate later in time.

In addition to these considerations that directly relate to observed throughput and quality of service (QoS) performance of the mesh network, another important operational consideration is channel changes in order to meet regulatory requirements.

Operation of wireless radio communications today is regulated by the FCC, (and its counterparts in other countries). In particular, channel changes are mandated in order to vacate certain frequency channels and bar them from further use for a pre-determined amount of time once an active radar is detected operating on a channel.

Very similar to channel changes motivated by interference and performance considerations, channel changes motivated because of regulatory requirements need to be addressed in a wireless mesh network.

In order for a mesh network to be able to overcome the above-mentioned conflicting needs, mesh systems need to be frequency-agile, which means they should be able to change channels. Such channel changes should be performed in a coordinated manner such that the channels changes are seamless and the QoS of end-users can be maintained.

While traditional wireless local area networks (WLANs) do not provide any means today to ensure seamless and coordinated frequency and channel changes, an amendment, (IEEE 802.11h), was made to WLAN medium access control (MAC) and physical layer (PHY) specifications in order to satisfy regulatory requirements for operation in the 5 GHz band in Europe.

However, IEEE 802.11h dynamic frequency selection (DFS) only allows WLAN systems in the 5 GHz band to co-exist with radar systems, but it does not provide the means by which channel changes can be performed in a manner that is seamless to the end-users and that ensures efficient use of the radio resources. Also, an IEEE 802.11h DFS-motivated channel change in an independent basic service set (IBSS) usually results in a break-up and re-establishment of the IBSS. An IBSS is a WLAN that operates without the need for an AP, (i.e., using an ad-hoc mode of the WLAN as opposed to BSSs which use an AP to relay traffic). But most importantly, the IEEE 802.11h amendment does not address the specific needs and constraints of mesh systems.

In summary, frequency agility while maintaining connectivity and QoS is an extremely desirable tool to improve the radio efficiency of mesh networks, but a method for achieving this feature is not provided by existing technology. Furthermore, a method for channel agility needs to be devised to allow mesh networks to meet certain regulatory requirements in the sense of IEEE 802.11h DFS, similar to WLANs today operating in legacy infrastructure, (BSS case), and Ad Hoc mode (IBSS case).

### SUMMARY

The present invention relates to wireless local area mesh networks by implementing various methods and signaling mechanisms in MPs in order to enable channel changes performed in a manner that is seamless to the end-users.

In one embodiment, a mesh network includes at least one channel master (CM) and a plurality of MPs. The CM sends a channel change intention message to at least one of the MPs indicating the CM's intention to change from a first channel to a second channel. Upon reception of the channel change intention message, the at least one MP determines whether to switch from the first channel to the second channel. The at least one MP sends a channel change response message to the CM. The CM then determines whether to change from the first channel to the second channel based on the channel change response message. The channel change intention message may indicate a change of mode, a change of bandwidth or a change of a number of channels. The channel change intention message may indicate the timing of the channel change.

### BRIEF DESCRIPTION OF THE DRAWINGS

A more detailed understanding of the invention may be had from the following description of a preferred example, given by way of example and to be understood in conjunction with the accompanying drawings wherein:

FIG. 1A is a signal flow diagram illustrating method steps implemented by a CM and two MPs in accordance with the present invention;

FIG. 1B is a signal flow diagram illustrating method steps implemented by an interfered MP to request its CM to change channels in accordance with the present invention;

FIG. 1C is a signal flow diagram illustrating method steps implemented by an arbitrary MP to indicate to other MPs that it will change channels in accordance with the present invention; and

FIG. 2 is a block diagram of a wireless mesh network including a CM and at least one MP in accordance with the present invention.

### DETAILED DESCRIPTION OF THE PREFERRED EMBODIMENTS

Hereafter, the terminology “access point,” (hereinafter referred to as “AP”), includes but is not limited to a base station, a Node-B, a site controller, an access point or any other type of interfacing device in a wireless environment.

The features of the present invention may be incorporated into an integrated circuit (IC) or be configured in a circuit comprising a multitude of interconnecting components.

The present invention solves the above-mentioned problem by providing different hand-shaking procedures and signaling mechanisms that will provide the means by which mesh systems can switch channels in a coordinated fashion. The present invention addresses both scenarios where the relationship between MPs is one of equals, (later referred as a “distributed” scenario), and where the relationship between MPs is one of master and slave, (later referred as “master-slave” scenario). In the latter scenario, the master responsible for dictating the channels to be used will be referred to as Channel Master (CM).

The IEEE 802.11standard does not provide any means by which the different nodes within mesh systems could change channels in a coordinated manner and in a manner that the channel change is seamless to the end-users.

An amendment, (IEEE 802.11h), was made to WLAN MAC and PHY specifications in order to satisfy regulatory requirements for operation in the 5 GHz band in Europe. The amendment is meant to allow WLAN systems in the 5 GHz band to co-exist with radar systems but it does not provide the means by which channel changes can be performed in a manner that is seamless to the end-users and that ensures efficient use of the radio resources. Moreover, the amendment does not address the specific needs of mesh systems.

The present invention solves all the limitations identified above, thus allowing seamless channel change in mesh without service interruption and without dramatic reduction of the efficiency of the wireless medium.

The present invention includes:

1) Signaling by which MPs exchange frequency/channel, (i.e., channel numbers or identifiers), capabilities as well as mode, (e.g., IEEE-802.11a, b, g, n, j, or the like), and operational bandwidth, (IEEE-802.11n 10/20 or 40 MHz, 11j 10 or 20 MHz), capabilities.

2) A method by which the CM initiates a channel change procedure.

3) A method by which an interfered MP can request its CM to change channels.

4) A mechanism by which an arbitrary MP communicates to other MPs in the mesh that it will change channels.

5) A method by which a given MP is elected as CM.

6) A method and procedure for channel switching in the mesh network to meet regulatory requirements.

I. Signaling by which MPs exchange frequency/channels, mode and operational bandwidth capabilities

Because of the need for neighboring MPs to share a common channel if they want to communicate together, the distribution of frequency/channel and mode capabilities is of paramount importance in the channel coordination of a mesh system. In a distributed scenario, this translates in MPs exchanging this information together. In a master-slave, scenario, it involves the slave MPs sending this information to their CM. The following describes the associated signalling in more details.

A CM or any MP can request an MP to report their capability information. The message can be sent using a unicast, a multicast or a broadcast. Alternatively, an MP can report its capability information to the CM or other MPs in an un-solicited manner, (e.g., as part of other signalling exchanges needed in order to establish connectivity such as authentication), or in a solicited manner, (e.g., when explicitly requested).

These capability information messages include, but are not limited to:

1) The channel numbers or channel identifiers on which the MP is able to operate on.

2) The modes the MP is able to support, (e.g., IEEE 802.11a, b, g, n, j, or the like).

3) The operational bandwidth the MP is able to support, (e.g., IEEE 802.11n 10, 20 or 40 MHz, IEEE 802.11j-10 or 20 MHz).

4) The number of simultaneous channels on which the MP is capable of operating , (e.g., 1 single channel or 2 or more simultaneous channels 10, 20 or 40 MHz-wide and so on).

5) The number of bands within which the MP is capable of operating on simultaneously, (2.4 GHz only, 5 GHz only, 2.4 and 5 GHz simultaneously and so on).

6) Frequency agility parameters such as channel dwell time, minimum channel switch time, configuration and duration of mandated silence periods for measurement purposes and so on.

7) Any combination of the above, (e.g., channels per band as a function of operational bandwidth setting and so on).

A CM or any MPs may broadcast their capability information using either broadcast or beacon-like frames or directed frames, such as mesh BEACON frames, mesh PROBE REQUEST frames or the like.

II. A method by which the CM initiates a channel change procedure

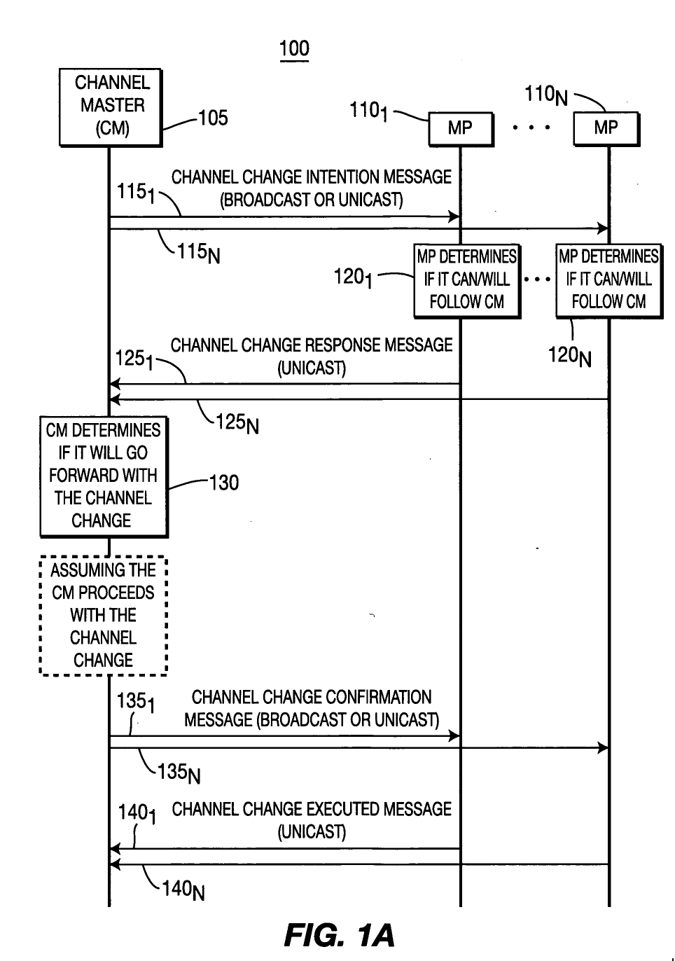

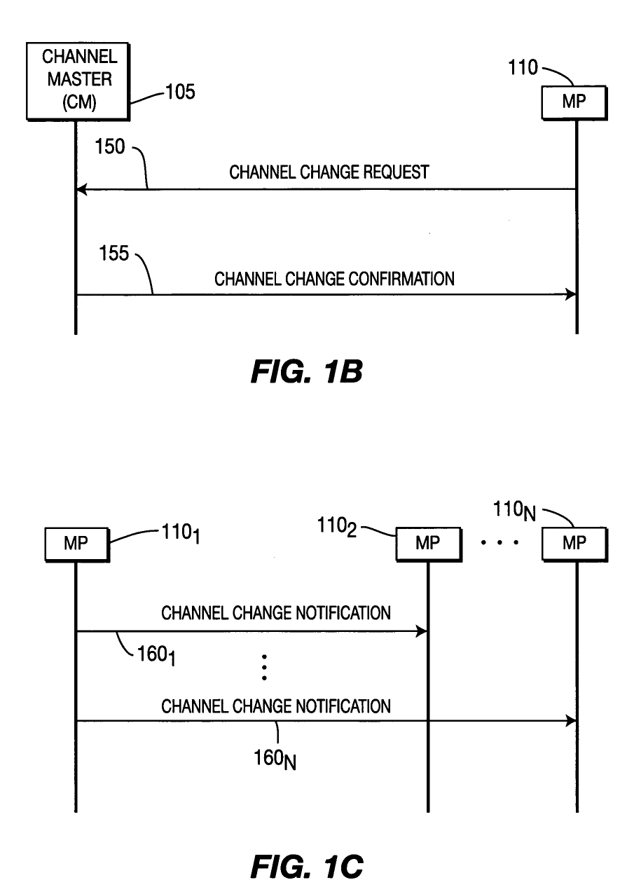

FIG. 1 is a flow diagram of a method implemented in a wireless communication system 100 including a CM 105 and a plurality of MPs 110₁- 110_{N}. The CM 105 sends the MPs 110₁- 110_{N} a channel change intention message 115 indicating the CM's intention to change from channel X to channel Y, where X and Y represent channel identifiers. In addition to the change of channels, the message 115 can also contain a change of mode, change of bandwidth or change of number of channels. The message 115 also contains information relative to the timing of this change.

This message 115 can be sent using a broadcast frame or a unicast frame. The advantage of using a broadcast frame is that it limits the number of message sent over the wireless medium (WM); while the advantage of using a unicast frame, (one for each associated MP 110), is that it tends to increase the robustness of the signaling since the CM 105 expects a MAC acknowledgement (ACK) from the MP 110 indicating whether or not the MP 110 has correctly received the message. In the case where no ACK would be received from a certain MP 110, the CM 105 could send the channel change intention message again.

Upon reception of the channel change intention message, each of the MPs 110 determines if it will switch its channel to the new channel based on its capabilities, the radio frequency (RF) environment it perceives from its location and the availability of other CMs/routes in the mesh network (steps 120₁-120_{N}).

Once this is determined, each of the MPs 110₁- 110_{N} sends a channel change response message 125 which can include a notification that the message was received, (applicable in the case where the channel change intention message is sent using a broadcast), or an indication as to whether or not the MP will follow the CM on its new channel. This information could contain various pre-defined responses, including but not limited to:

1) The MP will follow the CM on the new channel.

2) The MP would like to continue to be served by the CM on the same channel. This could be the case, for instance, if the MP's scanning indicates that the new channel will degrade its performance, if it lacks the capabilities to change channels, or if it determines that changing the channel will not allow it to satisfy QoS requirements of traffic it served and it has no alternative route outside from the cluster. 3) The MP will not follow the CM on the new channel, but does not request the CM to stay on the same channel. This could be the case, for instance, if the MP has identified another candidate CM which it feels can offer better performance than the current CM on the new channel.

Based on the channel change response notification message 125 received from its MPs 110, the CM 105 then determines whether or not it is going to change channels (step 130). This step 130 allows the CM 105 to reconsider its intention to change channels. For example, in the cases where the CM 105 only serves a single MP 110 and this MP 110 indicates that it cannot follow on the new channel, the CM 105 might decide not to perform the channel change. This is also an opportunity for the CM 105 to request measurements from the MPs 110 if it believes that measurement reports will help it to make a better decision.

If the CM 105 decides to go forward with the channel change, it would then send a channel change confirmation message 135 to each of the MPs 110₁- 110_{N}. The message 135 also contains information relative to the timing of this channel change. This message 135 can be sent using a broadcast frame or a unicast frame. If the CM 105 decides to go forward with the channel change, it can use the information contained in the channel change response it got from the MP 110 and distribute it amongst MPs 110 so they can adjust their routing tables. This will prevent the CM 105 and MPs 110 from wasting a considerable amount of bandwidth in unsuccessfully transmitting packets to MP 110 that have not followed on the new channel.

A supplementary step which could also be used is to have the MPs 110 send the CM 105 a channel change executed message 140 after it has changed channels. This information may be used to prevent the CM 105 from wasting a considerable amount of bandwidth in unsuccessfully transmitting packets to MPs that have not changed to the new channel.

III. A method by which an interfered MP can request its CM to change channels

The method comprises a hand-shaking procedure which enables an MP to request the CM for the mesh, (or the subset of the mesh under the control of the CM), to switch channels. The need for such a request may arise when the interference or channel activity perceived by the MP is such that it jeopardizes QoS of the traffic it serves.

As shown in FIG. 1B, an interfered MP 110 may send a change channel request message 150 to its CM 105. The change channel request message 150 is sent as a unicast frame, which is a frame that is destined to a single destination node but which does not prevent multiple nodes to be involved in the delivery and forwarding of the packet to the destination node. The change channel request message 150 may include some or all of the following information:

1) time limit for performing the channel change;

2) a list of preferred channel on which to migrate;

3) interference or noise level measurements on the current and candidate channels;

4) a list of neighboring MPs 110; and

5) routing metrics.

Upon reception of this message, the CM 105 can then take different courses of actions:

i) The CM 105 may initiate the hand-shaking procedure specified in section II. This course of action may be preferred in cases where the CM 105 controls a multiplicity of MPs 110.

ii) As shown in FIG. 1B, the CM 105 may send a channel change confirmation message 155 without conveying its intention to do so to the MPs 110.

iii) The CM 105 may decide to ignore the message from the interfered MP 110.

At any point in the flow of events described above, the CM 105 may perform measurements on the current and proposed channels and/or request measurements from the MP 110 requesting the channel change or from any MP 110 under the control of the CM 105.

IV. A method mechanism by which an arbitrary MP communicates to other MPs in the mesh that it will change channels

In the purely distributed case, as shown in FIG. 1C, (i.e., MPs 110 are peers and a CM per se does not exist), it is the responsibility of each individual MP 110 to determine which channels to use. The MPs 110 still have strong incentives to communicate to the other MPs 110 that they need to switch channels. This enhances the probability that the neighboring MPs 110 will follow the MP which has to change channels.

As shown in FIG. 1C, the method comprises a signaling procedure which enables an MP 110₁ to notify one or multiple MPs 110₂- 110_{N} of the mesh that the interfered MP 110₁will switch channels. The need for such a method may arise when the interference or channel activity perceived by the interfered MP 110₁ is such that it jeopardizes QoS of the traffic it serves, or when it needs to change channels as mandated by regulatory requirements.

As shown in FIG. 1C, the interfered MP 110₁ sends one or more channel change notification messages 160₁-160_{N} enabling the interfered MP 110₁ to notify one or multiple MPs 110₂-110_{N} of the mesh that the interfered MP 110₁ will switch from channel Y to channel Z. In addition to the change of channels, the channel change notification messages 160₁-160_{N} may also contain a change of mode, change of bandwidth or change of number of channels. The message may also contain information relative to the timing of this change. The message may be sent using a unicast, multicast or broadcast. The advantage of using a broadcast frame is that it limits the number of messages sent over the Wireless Medium (WM); while the advantage of using a unicast frame, (one for each associated MP 110), is that it tends to increase the robustness of the signaling since the sender of the frame expects a MAC acknowledgement (ACK) indicating whether or not the target MP has correctly received the message. In the case where no ACK would be received from a certain target MP, the interfered MP 110₁could send the channel change intention message again.

The channel change notification message 160 may include some or all of the following information:

1) time limit for performing the channel change;

2) a list of preferred channel on which to migrate;

3) interference or noise level measurements on the current and candidate channels; and

4) routing metrics.

Upon reception of the channel change notification message 160, any neighboring MP 110 may then take different courses of actions. For example, one of the MPs 110₂- 110_{N} that receives the channel change notification message 160 may decide to follow the interfered MP 110₁, in which case it would also send a channel change notification message 160 to its neighbors, or it could decide to ignore the channel change notification message 160 received from the interfered MP 110₁.

V. A method by which a given MP is elected as CM

Operation with a CM supposes MPs negotiate and agree upon a CM first, this is called the CM (re-)selection procedure. Different possibilities and procedures exist to determine a CM as follows:

1) The first MP in the mesh automatically becomes a CM.

2) An MP at switch-on determines if one of its neighbors is a CM. The CM can be identified by means of layer 2 (L2) or layer 3 (L3) broadcast, multicast or dedicated signaling received by the MP as part of the set-up procedures, (e.g., authentication, mesh BEACON frame reception, capability exchanges, or the like).

3) The CM can be pre-set, i.e. fixed for the lifetime of the mesh network or time-limited, (i.e., after a certain pre-determined amount of time or tied to the occurrence of certain conditions the CM selection procedure is re-initiated).

4) In one advantageous realization, the CM coincides with the mesh portal, therefore automatically pointing to the CM. A portal is referred to as the point of interconnection between a mesh network and a non-mesh network, (e.g., Ethernet connected to the Internet through a router).

5) The MPs with the most links to neighbors becomes the CM.

6) The MPs determine the CM by means of a random number draw and the MPs exchanging with each other this randomly generated number to determine which MP becomes the MP.

7) The MPs determine the CM as a function of the number of hops from the mesh portal or from a certain agreed-upon MP.

8) Any combination of the above.

The signaling needed to identify the CM according to the methods described above comprises the following steps:

1) A request information element (IE) part of a broadcast/multicast/unicast signaling frame is sent through the mesh network indicating to neighbor MPs the need for CM selection containing the address of the originating MP and other parameters, such as time-out values, selection criterion, default identifier for the proposed CM, reply-to address and so on.

2) A response IE part of a broadcast/multicast/unicast signaling frame containing the selection criterion response is sent through the mesh network.

3) A comparison procedure in the MPs is performed where the selection criterion responses from different neighbor MPs are evaluated and a decision is made which MP meets the requirements in terms of the chosen selection criterion, (e.g., highest random number drawn or similar).

The CM uses the procedures described in section IV to execute and coordinate channel switches amongst nodes in the mesh.

VI. Method and procedure for channel switching in the mesh to meet regulatory requirements

The procedure comprises of the following steps:

1) At switch-on, as part of (re-)association or (re-)authentication, periodically, solicitated or un-solicitated, MPs exchange capability information as described in section I.

2) Mesh DFS relevant parameters, (e.g., CM identifier, time-out values, dwell timers, measurement intervals and silence periods and so on), are sent on mesh BEACON or PROBE REPONSE frames, or by unicast frames, to all MPs.

3) All or a subset of MPs perform measurements and report these measurements back to the CM, alternatively or in combination with, each MP evaluates these measurements against occurrence of radar or other trigger conditions.

4) When radar or any other valid trigger condition is detected, MPs report these trigger conditions to the CM by means of broadcast/multicast or unicast frames, alternatively or in combination, announce the detected radar or triggering condition to neighbor MPs and wait for a certain predetermined amount of time for a reply initiating a frequency change from the CM.

5) The CM, (or the MP itself), sends a mesh channel switch announcement (MCSA) either as an IE part of any other mesh broadcast/multicast or unicast message or as a stand-alone mesh broadcast/multicast or unicast signaling frame either to all or a subset of MPs under its responsibility. This MCSA contains all necessary parameters such as recommended, preferred or mandated switch time, new channel, mode and bandwidth settings. This MCSA signaling can affect only one particular mesh-link, a group of mesh-links, or change the settings of all MPs. The CM can take into account the capabilities of the MPs as signaled by message 115 of FIG. 1. This signaling can also contain mandated silence periods and other operation settings affecting frequency.

6) The MPs which have received the MCSA will change their frequency settings according to the information received by a channel change confirmation message 135, as shown in FIG. 1. They may or may not acknowledge successful reception or execution of the changes in the channel change confirmation message 135 of FIG. 1 to the CM.

VII. Implementation and configuration

The signaling messages and information exchanged between MPs or between MPs and the CM as described in sections I-VI may be implemented by either L2, (e.g., MAC layer), signaling frames or IEs (preferred embodiment), L3 or above signaling packets or IEs, (e.g., encapsulated into Internet Protocol (IP) packets, transmission control protocol (TCP)/IP packets or the like), or a combination thereof.

Similar, the procedures described in sections I-VI may be implemented as part of either L2 hardware/software in a MAC or a sublayer management entity (SME) (preferred embodiment), above layer 2 (L2) software, for example part of the operation and maintenance (O&M) routines in MPs, or a combination thereof.

All methods described in sections I-VI may be subject to, or are complemented by, configuration settings in the individual MPs and may provide statistics and feedback to mesh-internal or external network monitoring and control entities that can exercise control on MPs' operational characteristics.

These configuration settings and reportable statistics can be set in, or reported from, individual MPs or groups of MPs by:

1) databases in PHY, MAC or SME, advantageously realized in, (but not limited to), the form of management information bases (MIBs);

2) signaling messages between L2 MAC or SME to above protocol entities, advantageously realized in, (but not limited to), the form of APIs; or

3) primitives exchanged between SME, MAC, PHY and other protocol entities in a MP implementation or a combination thereof.

Configuration settings that can be used by external management entities on the MP, (or groups of MPs), may contain an admissible frequency channel and/or channel ranges, admissible mode settings, (e.g., IEEE 802.11a, b, g, j, n or the like), admissible band settings, (e.g., 2.4 GHz, 4.9 GHz, 5 GHz, or the like), admissible bandwidth settings, (e.g., 10/20/40 MHz or the like), admissible number of max channels, (e.g., single channel, two channels, or the like), frequency agility on or off, addresses and identifiers for CM, timer values, (e.g., channel dwell and measurement intervals), for frequency agility, frequency switch command for the MP or any combination thereof.

Reportable statistics in the MP that can be used by external management entities can be either, current channels, modes, bandwidth, number of simultaneous channels, (or combination thereof), of MPs and neighbor MPs, (as far as known), channel statistics such as the value and type of measurements performed and so on, or any combination thereof.

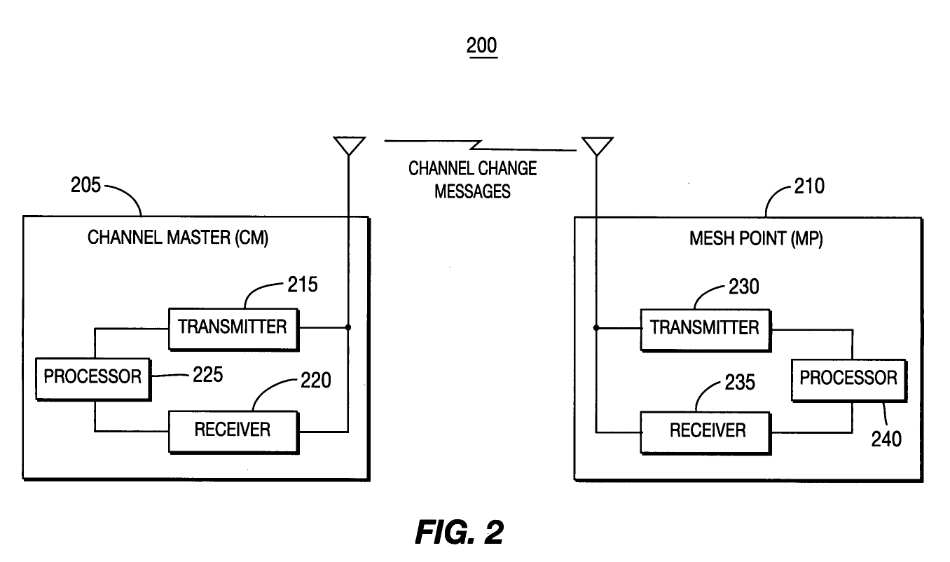

FIG. 2 is a block diagram of a wireless mesh network 200 including a CM 205 and an MP 210 in accordance with the present invention. Although only one MP is shown for illustrative purposes, it should be understood by one of ordinary skill in the art that the mesh network 200 may include a plurality of MPs having a configuration similar to that of the MP 210 illustrated in FIG. 2.

As shown in FIG. 2, the CM 205 includes a transmitter 215, a receiver 220 and a processor 225, and the MP 210 includes a transmitter 230, a receiver 235 and a processor 240. The processor 225 of the CM 205 generates a channel change intention message which is transmitted by the transmitter 215 to at least one MP 210. The channel change intention message indicates the intention of the CM 205 to change from a first channel to a second channel. After the channel change intention message is received by the receiver 235 in the at least one mesh point 210, the processor 240 in the least one MP 210 determines whether the MP 210 should switch from the first channel to the second channel. If so, the transmitter 230 of the at least one MP 210 sends a channel change response message generated by the processor 240 to the CM 205. After the channel change response message is received by the receiver 220 in the CM 205, the processor 225 in the CM 205 determines whether to change from the first channel to the second channel based on the channel change response message.

The channel change intention message may indicate a change of mode, a change of bandwidth, a change of a number of channels or the timing of the channel change. Either a broadcast frame or unicast frame may be used to send the channel change intention message. The channel change response message may include a notification confirming receipt of the channel change intention message. The channel change response message may indicate whether the MP 210 will change from the first channel to the second channel. The processor 240 in the MP 210 may determine whether to switch from the first channel to the second channel based on the RF environment of the MP 210 or based on the availability of other CMs in the mesh network.

Although the features and elements of the present invention are described in the preferred embodiments in particular combinations, each feature or element can be used alone without the other features and elements of the preferred embodiments or in various combinations with or without other features and elements of the present invention.

What is claimed is:

1. In a mesh network including at least one channel master (CM) and a plurality of mesh points (MPs), a method comprising:
a) the CM sending a channel change intention message to at least one of the MPs, the message indicating the CM's intention to change from a first channel to a second channel;
b) upon reception of the channel change intention message, the at least one MP determining whether to switch from the first channel to the second channel;
c) the at least one MP sending a channel change response message to the CM; and
d) the CM determining whether to change from the first channel to the second channel based on the channel change response message.

2. The method of claim 1 wherein the channel change intention message indicates a change of mode.

3. The method of claim 1 wherein the channel change intention message indicates a change of bandwidth.

4. The method of claim 1 wherein the channel change intention message indicates a change of a number of channels.

5. The method of claim 1 wherein the channel change intention message indicates the timing of the channel change.

6. The method of claim 1 wherein a broadcast frame is used to send the channel change intention message.

7. The method of claim 1 wherein a unicast frame is used to send the channel change intention message.

8. The method of claim 1 wherein the channel change response message includes a notification confirming receipt of the channel change intention message.

9. The method of claim 1 wherein the channel change response message indicates whether the MP will change from the first channel to the second channel.

10. The method of claim 1 wherein the at least one MP determines whether to switch from the first channel to the second channel based on the MP's radio frequency (RF) environment.

11. The method of claim 1 wherein the at least one MP determines whether to switch from the first channel to the second channel based on the availability of other CMs in the mesh network.

12. A mesh network comprising:
a) at least one channel master (CM); and
b) a plurality of mesh points (MPs), wherein:
i) the CM sends a channel change intention message to at least one of the MPs, the message indicating the CM's intention to change from a first channel to a second channel;
ii) the at least one MP determining whether to switch from the first channel to the second channel upon reception of the channel change intention message;
iii) the at least one MP sends a channel change response message to the CM; and
iv) the CM determines whether to change from the first channel to the second channel based on the channel change response message.

13. The mesh network of claim 12 wherein the channel change intention message indicates a change of mode.

14. The mesh network of claim 12 wherein the channel change intention message indicates a change of bandwidth.

15. The mesh network of claim 12 wherein the channel change intention message indicates a change of a number of channels.

16. The mesh network of claim 12 wherein the channel change intention message indicates the timing of the channel change.

17. The mesh network of claim 12 wherein a broadcast frame is used to send the channel change intention message.

18. The mesh network of claim 12 wherein a unicast frame is used to send the channel change intention message.

19. The mesh network of claim 12 wherein the channel change response message includes a notification confirming receipt of the channel change intention message.

20. The mesh network of claim 12 wherein the channel change response message indicates whether the MP will change from the first channel to the second channel.

21. The mesh network of claim 12 wherein the at least one MP determines whether to switch from the first channel to the second channel based on the MP's radio frequency (RF) environment.

22. The mesh network of claim 12 wherein the at least one MP determines whether to switch from the first channel to the second channel based on the availability of other CMs in the mesh network.
